(19) United States
(12) Patent Application Publication
(10) Pub. No.: US 2001/0041102 A1
(43) Pub. Date: Nov. 15, 2001

(54) Apparatus and method for fluidizable solids metering and pneumatic conveyance

(75) Inventors: Helmut Huber, Emmerting (DE); Helmut Wohrl, Altotting (DE); Johann Schuster, Emmerting (DE)

Correspondence Address: William G. Conger, Brooks & Kushman P.C, 22nd Floor, 1000 Town Center, Southfield, MI, 48075-1351, US

(73) Assignee: Wacker-Chemie GmbH, Munchen (DE)

(21) Appl. No.: 09/845,893

(22) Filed: Apr. 30, 2001

(30) Foreign Application Priority Data
May 11, 2000 (DE) 100 22 998.0

(51) Int. Cl. B65G 53/48

(52) U.S. Cl. 406/108; 406/171

(57) ABSTRACT

The invention relates to a pneumatic conveying system, comprising an apparatus for gravimetric solids metering, wherein a readily fluidizable material to be conveyed is fed to a conveying line, culminating with a mixer into which the fluidizable material is conveyed from the conveying line. A degassing screw located between the gravimetric solids metering system and the mixer allow for transfer of conveyed solids into the mixer without pressure buildup and without altering the weight ratio of the filler to product.

### BACKGROUND OF THE INVENTION

1. Field of the Invention

The invention relates to an apparatus and a method for the and pneumatic conveyance of fluidizable solid materials.

2. Background Art

Pneumatic pipe conveyance systems have been used for long-distance conveyance of readily fluidizable bulk materials such as highly disperse silicic acid. Such system usually include a pressure vessel upstream of the pneumatic conveyance system. Metering of solids into the pipe conveyance system has been accomplished by means of a compressed-air diaphragm pump. However, when metering solids by means of such diaphragm pumps, it is possible for an excess pressure of several mbar to build up disadvantageously and lead to problems at the exit of the conveying system, if the product is being further processed there directly and if such further processing depends on exact metering of the conveyed material. For example, when further processing is being carried out in a mixer, the effect mentioned leads to inhomogeneous distribution within the mixture.

For the same reason, it was previously not possible to perform solids metering to a closed mixer by means of a compressed-air diaphragm pump. In closed mixers, the excess pressure causes interleaving of the solid substance, leading to inhomogeneous distributions within the mixtures.

### SUMMARY OF THE INVENTION

It is an object of the invention to modify a pneumatic conveying system in such a way that pressure build up and inhomogenous distributions in mixing processes employing conveyed solids no longer occurs.

These and other objects are achieved by a pneumatic conveying system comprising an apparatus for gravimetric solids metering, in which a readily fluidizable solids material to be conveyed is fed to a conveying line and from there into a closed mixer, wherein a degassing screw is located between the gravimetric solids metering system and the mixer.

### BRIEF DESCRIPTION OF THE DRAWINGS

FIG. 1 illustrates one embodiment of a conveying system in accordance with the subject invention.

### DETAILED DESCRIPTION OF THE PREFERRED EMBODIMENT(S)

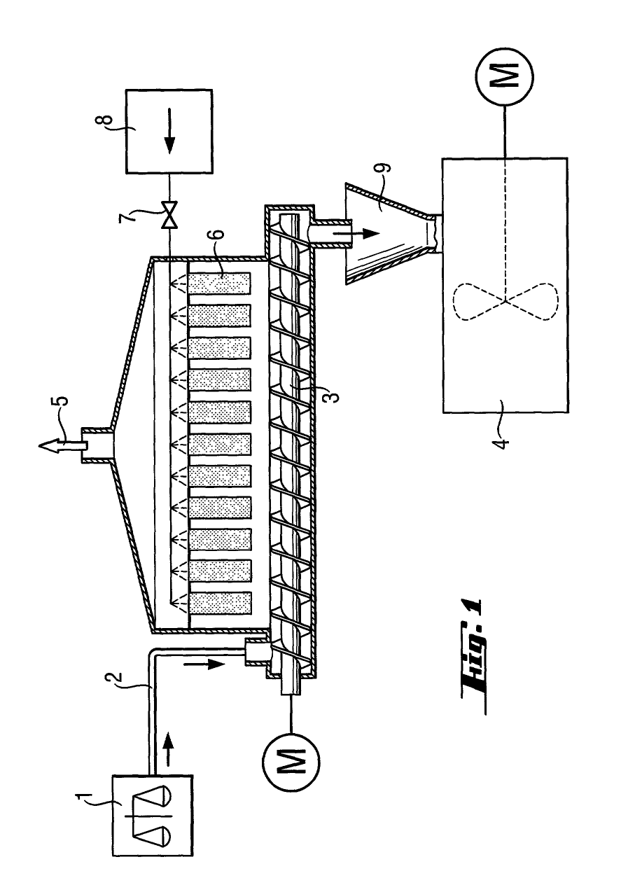

One embodiment of a conveying system according to the invention may be described with reference to FIG. 1. The pneumatic conveying system comprises a gravimetric weighing system (1), a conveying line (2), a degassing screw (3) and a mixer (4), the degassing screw (3) having a waste-air system (5). The degassing screw (3) and the mixer (4) are preferably each driven by means of a motor (M). Between the degassing screw (3) and the mixer (4) there is preferably a feed hopper (9).

The invention also relates to a degassing screw (3) which has a waste-air system (5). The waste-air system (5) of the degassing screw (3) is preferably provided with a an efficient particulate filter (6). The filter (6) can preferably be cleaned by means of a valve (7) and a pressure vessel (8).

The apparatus according to the invention is suitable in particular for bulk materials at rates of preferably 500 g/h to 200 kg/h. Solid substances with a very pressure-dependent apparent density can also be exactly metered and conveyed by the inventive system.

The apparatus can be used, for example, for metering and conveying fine-particle size fillers, for example for preparing polymer mixtures, antifoaming agents and so on. The apparatus is particularly well suited for the metering and conveying of fine-particle fluidizable bulk materials into continuously operating dynamic mixers.

Examples of fillers which can be metered and transported by the apparatus according to the invention are non-reinforcing fillers, that is fillers with a BET surface area of up to 50 m²/g, such as, in a non-limiting sense, quartz, diatomaceous earth, calcium silicate, zirconium silicate, zeolites, metal oxide powders such as aluminum, titanium, iron or zinc oxides or mixed oxides of these and other metals, barium sulfate, calcium carbonate, gypsum, silicon nitride, silicon carbide, boron nitride, glass and polymer powders; reinforcing fillers, that is fillers with a BET surface area of over 50 m²/g, such as pyrogenically produced silicic acid, precipitated silicic acid, carbon black such as furnace black and acetylene black, and silicon-aluminum mixed oxides of large BET surface area; and fibrous fillers, such as asbestos and polymer fibers. The fillers mentioned may be hydrophobicized, for example by treatment with organosilanes or organosiloxanes or by etherification of hydroxyl groups into alkoxy groups.

The apparatus according to the invention is particularly suited for the metering of highly disperse silicic acid.

The invention also relates to a method for metering and pneumatic conveyance of a fluidizable bulk solids material.

This method proceeds as follows: the bulk material is introduced by means of a gravimetric weighing system (1) through a conveying line (2) into a degassing screw (3). In the degassing screw (3), the degassing and settling behavior of the bulk material is set. This can take place for example by varying the rotational speed of the degassing screw (3) and also by varying the length of the degassing screw (3). The degassing screw (3) has a waste-air system (5), through which excess gas can, if required, be discharged from the system in a controlled manner. This gas is preferably expelled from the degassing screw (3) via the filter (6). Consequently, the already weighed product ratio is no longer changed. When the product has run through the degassing screw (3), it preferably passes via the feed hopper (9) into the mixer (8). The screw is preferably operated at a constant rotational speed for one batch.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. In a pneumatic conveying system wherein fluidizable solids metered gravimetrically are conveyed through a conveying line to a closed mixer, the improvement comprising locating a degassing screw prior to said mixer.

2. The pneumatic conveying system of claim 1, comprising a gravimetric weighing system, a conveying line, a degassing screw, and a mixer, wherein the gases removed via the degassing screw exit into a waste-air system.

3. The pneumatic conveying system of claim 1, wherein between the degassing screw and the mixer there is a feed hopper.

4. A degassing screw having a waste-air system.

5. The degassing screw as claimed in claim 4, wherein the waste-air system is provided with a particulates filter.

6. The degassing screw as claimed in claim 5, wherein the particulates filter can be cleaned by means of a valve and a pressure vessel.

7. A method for the pneumatic conveyance of a readily fluidizable solids material, comprising introducing the material to be conveyed into a conveying line by means of a gravimetric weighing system and transporting fluidized solids through this line to a degassing screw, wherein the degassing or settling behavior of the fluidized solids is fixed in the degassing screw such that the already weighed product ratio remains unchanged, and introducing the degassed solids material into a mixer.

8. The method of claim 7, wherein the degassing and/or settling behavior of the material being conveyed is adjusted by varying the rotational speed of the degassing screw or by varying the length of the degassing screw.

9. The method of claim 7, wherein the gas is discharged from the system via a filter.

10. The method of claim 8, wherein the gas is discharged from the system via a filter.

11. The method of claim 7, wherein the degassing screw is operated at a constant rotational speed for a given batch.

12. The method of claim 8, wherein the degassing screw is operated at a constant rotational speed for a given batch.

13. The method of claim 9, wherein the degassing screw is operated at a constant rotational speed for a given batch.

14. The method of claim 10, wherein the degassing screw is operated at a constant rotational speed for a given batch.
